(19) United States
(12) Patent Application Publication
(10) Pub. No.: US 2024/0292141 A1
(43) Pub. Date: Aug. 29, 2024

(54) CHARGING BOX AND STORAGE BOX

(71) Applicant: DEXIN CORP., New Taipei City (TW)

(72) Inventors: Ho Lung LU, New Taipei City (TW); Ya-Hsiu TSAI, New Taipei City (TW)

(73) Assignee: DEXIN CORP., New Taipei City (TW)

(21) Appl. No.: 18/114,071

(22) Filed: Feb. 24, 2023

(51) Int. Cl. H04R 1/10; H02J 7/00

(52) U.S. Cl. CPC H04R 1/1025; H02J 7/0044; H02J 7/342; H04R 1/083; H04R 1/1058; H04R 2460/17

(57) ABSTRACT

A charging box is configured to accommodate at least one wireless earphone and at least one microphone. The charging box includes a casing, a cover and a charging system. The casing has at least one inner accommodation recess and at least one outer accommodation recess. The at least one inner accommodation recess is configured to accommodate the at least one wireless earphone. The at least one outer accommodation recess is configured to accommodate the at least one microphone. The cover is mounted at the casing, and the cover is configured to cover the at least one inner accommodation recess. The charging system is disposed in the casing, and the charging system is configured to charge the at least one wireless earphone.

### TECHNICAL FIELD

The present disclosure relates to a charging box and a storage box, more particularly to a charging box and a storage box which accommodate earphones and a microphone.

### BACKGROUND

As wireless technology progresses, various wireless earphones are launched on the market so that users can enjoy a wearing experience that is not restricted by wires during static or dynamic activities. In order to meet the basic needs such as reception and transmission of voice, the wireless earphones are equipped with not only relevant components that convert the electrical current into sound but also a microphone for collecting the speaker's voice. The wireless earphones may generally be cooperated with a built-in microphone or an external plug-in microphone. The built-in microphone is integrated in the wireless earphones, while the external plug-in microphone is independent from the wireless earphones, and the external plug-in microphone is plugged into the wireless earphones via connectors.

In order to increase a battery life of the wireless earphones, a charging box is generally designed to charge the wireless earphones. But, as for the wireless earphones with the external plug-in microphone plugged therein, when the user wants to charge the wireless earphones, the user needs to separate the wireless earphones from the external plug-in microphone at first, and then the user puts the wireless earphones into the charging box. However, the external plug-in microphone, separated from the wireless earphones, needs to be accommodated additionally because the external plug-in microphone may be unable to be put into the charging box. Therefore, it is troublesome to accommodate the external plug-in microphone, and the external plug-in microphone may be easily lost due to improper accommodation.

### SUMMARY

The present disclosure provides a charging box and a storage box which enables the earphones and the microphone to be accommodated properly and conveniently.

One embodiment of the disclosure provides a charging box configured to accommodate at least one wireless earphone and at least one microphone. The charging box includes a casing, a cover and a charging system. The casing has at least one inner accommodation recess and at least one outer accommodation recess. The at least one inner accommodation recess is configured to accommodate the at least one wireless earphone. The at least one outer accommodation recess is configured to accommodate the at least one microphone. The cover is mounted at the casing, and the cover is configured to cover the at least one inner accommodation recess. The charging system is disposed in the casing, and the charging system is configured to charge the at least one wireless earphone.

Another embodiment of the disclosure provides a charging box configured to accommodate at least one wireless earphone and at least one microphone. The charging box includes a casing, a cover and a charging system. The casing has at least one inner accommodation recess. The at least one inner accommodation recess is configured to accommodate the at least one wireless earphone. The cover is mounted at the casing, and the cover is configured to cover the at least one inner accommodation recess. The cover has at least one outer accommodation recess. The at least one outer accommodation recess is configured to accommodate the at least one microphone. The charging system is disposed in the casing, and the charging system is configured to charge the at least one wireless earphone.

Still another embodiment of the disclosure provides a storage box configured to accommodate at least one wireless earphone and at least one microphone. The storage box includes a casing and a cover. The casing has at least one inner accommodation recess. The at least one inner accommodation recess is configured to accommodate the at least one wireless earphone. The cover is mounted at the casing, and the cover is configured to cover the at least one inner accommodation recess. The casing or the cover has at least one outer accommodation recess, and the at least one outer accommodation recess is configured to accommodate the at least one microphone.

According to the charging box and the storage box as described above, the charging box has the at least one inner accommodation recesses and the at least one outer accommodation recess for accommodating the wireless earphones and the microphone, such that the wireless earphones and the microphone can be conveniently and properly accommodated by the charging box, and the microphone is prevented from being missing.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a charging box, wireless earphones and a microphone in accordance with the first embodiment of the disclosure;

FIG. 2 is another perspective view of the charging box, the wireless earphones and the microphone in FIG. 1;

FIG. 3 is an exploded view of the charging box, the wireless earphones and the microphone in FIG. 1;

FIG. 4 is another exploded view of the charging box, the wireless earphones and the microphone in FIG. 2;

FIG. 5 is a perspective view of one wireless earphone and the microphone in FIG. 3 when the wireless earphone and the microphone are assembled with each other; and

FIG. 6 is a partially enlarged schematic view of a casing of the charging box in FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

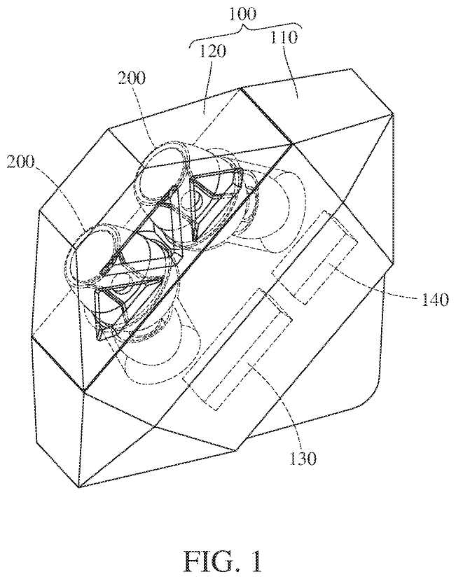

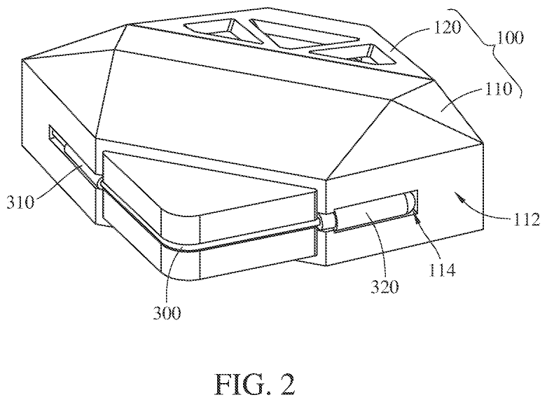

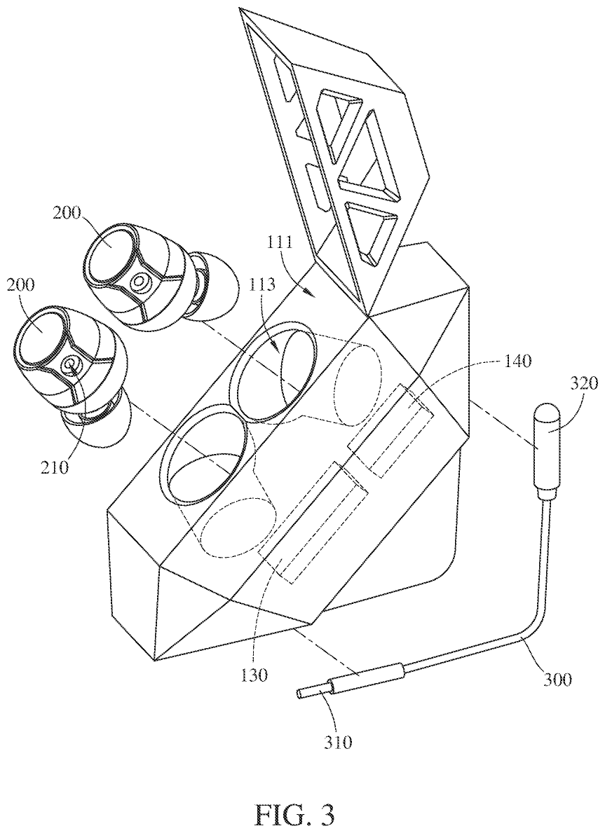

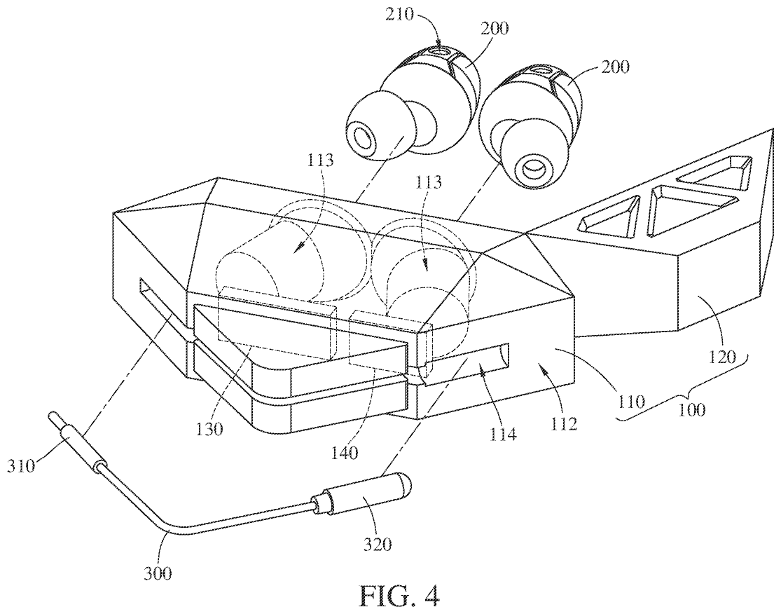

Please refer to FIG. 1 to FIG. 4, where FIG. 1 is a perspective view of a charging box in accordance with the first embodiment of the disclosure, wireless earphones and a microphone, FIG. 2 is another perspective view of the charging box, the wireless earphones and the microphone in FIG. 1. FIG. 3 is an exploded view of the charging box, the wireless earphones and the microphone in FIG. 1, and FIG. 4 is another exploded view of the charging box, the wireless earphones and the microphone in FIG. 2.

In this embodiment, the charging box 100 is configured to accommodate a pair of wireless earphones 200 and a microphone 300. Each of the wireless earphones 200 has a connector 210. The microphone 300 has a connector 310 and a sound receiving component 320, and the connector 310 and the sound receiving component 320 are respectively located at two opposite ends of the microphone 300. The connector 310 of the microphone 300 and the connectors 210 of the wireless earphones 200 are, for example, male contacts and female contacts of mono (Tip-Sleeve, TS) or stereo (Tip-Ring-Sleeve, TRS), respectively. The connector 310 of the microphone 300 is configured to be plugged into the connector 210 of one of the wireless earphones 200, and the microphone 300 is configured to receive a sound via the sound receiving component 320. In addition, the middle portion of the microphone 300 is, for example, made of a bendable material.

The charging box 100 includes a casing 110, a cover 120, a battery 130 and a charging system 140. The casing 110 has a first surface 111, a second surface 112, two inner accommodation recesses 113 and an outer accommodation recess 114. The second surface 112 faces away from the first surface 111. The two inner accommodation recesses 113 is located at the first surface 111. The outer accommodation recess 114 is located at the second surface 112. The two inner accommodation recesses 113 are configured to accommodate the two wireless earphones 200, respectively. The outer accommodation recess 114 is configured to accommodate the microphone 300.

The cover 120 is, for example, rotatably mounted at the casing, and the cover covers the two inner accommodation recesses 113. In detail, the cover 120 may be rotated relative to the casing 110 to be located at a closed position or an opened position. When the cover 120 is located at the closed position, the cover 120 covers the two inner accommodation recesses 113. When the cover 120 is located at the opened position, the two inner accommodation recesses 113 are exposed to outside.

The battery 130 and the charging system 140 are disposed in the casing 110. The charging system 140 charges the battery 130, and the charging system 140 is configured to charge the two wireless earphones 200 via the battery 130. Alternately, in another embodiment, the battery may be omitted, and the charging system may charge the two wireless earphones directly.

In this embodiment, the charging box 100 has the battery 130 and the charging system 140 for charging the wireless earphones 200, but the disclosure is not limited thereto. In other embodiments, the charging box may be modified as a storage box without the battery and the charging system. That is, the storage box merely has a function of accommodating the wireless earphones and the microphone, but does not have a function of charging the wireless earphones.

In this embodiment, the quantity of the wireless earphones 200 is two, but the disclosure is not limited thereto. In other embodiments, the quantity of the wireless earphone may be merely one. In addition, in this embodiment, the quantity of the microphone 300 is one, but the disclosure is not limited thereto. In other embodiments, the quantity of the microphones may be more than one.

In this embodiment, the outer accommodation recess 114 configured to accommodate the microphone 300 is located at the second surface 112, but the disclosure is not limited thereto. In other embodiments, the outer accommodation recess configured to accommodate the microphone may be located at an outer surface of the cover.

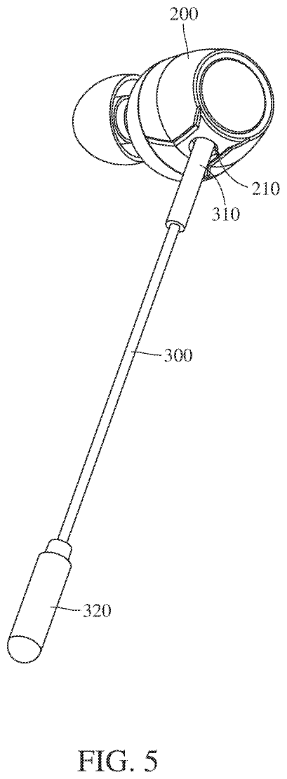

Please refer to FIG. 5, which is a perspective view of one wireless earphone and the microphone in FIG. 3 when the wireless earphone and the microphone are assembled with each other. When the user desires to use the wireless earphones 200 and the microphone 300, the user may take the wireless earphones 200 and the microphone 300 out of the inner accommodation recesses 113 and the outer accommodation recess 114, respectively, and the user may plug the connector 310 of the microphone 300 into the connector 210 of one of the wireless earphones 200. Then, the wireless earphones 200 may be put into the ears (not shown). When the user no longer uses the wireless earphones 200 and the microphone 300, the microphone 300 may be separated from the wireless earphones 200, and the wireless earphones 200 and the microphone 300 may be put into the inner accommodation recesses 113 and the outer accommodation recess 114, respectively. Therefore, the charging box 100 not only can charge the wireless earphones 200 and the microphone 300 via the charging system 140 in the casing 110, but also can accommodate the wireless earphones 200 and the microphone 300 together. As a result, the wireless earphones 200 and the microphone 300 can be accommodated properly and conveniently, and the microphone 300 is prevented from being missing.

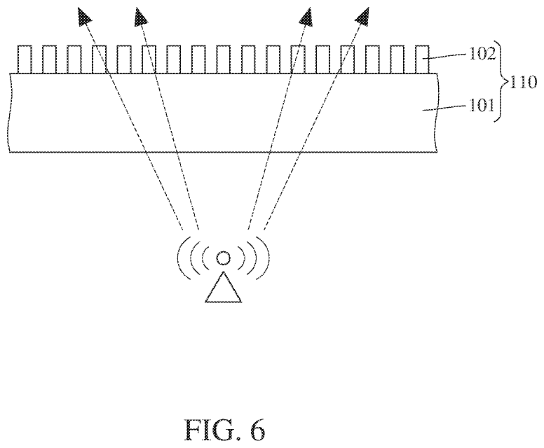

Please refer to FIG. 6, which is a partially enlarged schematic view of a casing of the charging box in FIG. 3. The casing 110 includes a shell layer 101 and a non-conductive film layer 102. The non-conductive film layer 102 is, for example, a non-conductive vacuum metallization (NCVM), and the non-conductive film layer 102 is coated on the shell layer 101 for avoid affecting a radio frequency (RF) performance and an electrostatic discharge (ESD) performance of a cellphone. That is, the wireless products may achieve a better communication quality, without noise, and the wireless products will not have any impact on the human body.

According to the charging box and the storage box as described above, the charging box has the inner accommodation recesses and the outer accommodation recess for accommodating the wireless earphones and the microphone, such that the wireless earphones and the microphone can be conveniently and properly accommodated by the charging box, and the microphone is prevented from being missing.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A charging box, configured to accommodate at least one wireless earphone and at least one microphone, comprising:
a casing, having at least one inner accommodation recess and at least one outer accommodation recess, the at least one inner accommodation recess is configured to accommodate the at least one wireless earphone, and the at least one outer accommodation recess is configured to accommodate the at least one microphone;
a cover, mounted at the casing, and the cover is configured to cover the at least one inner accommodation recess; and
a charging system, disposed in the casing, and the charging system is configured to charge the at least one wireless earphone.

2. The charging box according to claim 1, further comprising a battery, wherein the battery is disposed in the casing, the charging system charges the battery, and the charging system is configured to charge the at least one wireless earphone via the battery.

3. The charging box according to claim 1, wherein the casing has a first surface and a second surface, the second surface faces away from the first surface, the at least one inner accommodation recess is located at the first surface, and the at least one outer accommodation recess is located at the second surface.

4. The charging box according to claim 1, wherein a quantity of the at least one inner accommodation recess is two.

5. A charging box, configured to accommodate at least one wireless earphone and at least one microphone, comprising:
a casing, having at least one inner accommodation recess, and the at least one inner accommodation recess is configured to accommodate the at least one wireless earphone;
a cover, mounted at the casing, the cover is configured to cover the at least one inner accommodation recess, the cover has at least one outer accommodation recess, and the at least one outer accommodation recess is configured to accommodate the at least one microphone; and
a charging system, disposed in the casing, and the charging system is configured to charge the at least one wireless earphone.

6. The charging box according to claim 5, further comprising a battery, the battery is disposed in the casing, the charging system charges the battery, and the charging system is configured to charge the at least one wireless earphone via the battery.

7. The charging box according to claim 5, wherein a quantity of the at least one inner accommodation recess is two.

8. A storage box, configured to accommodate at least one wireless earphone and at least one microphone, comprising:
a casing, having at least one inner accommodation recess, and the at least one inner accommodation recess is configured to accommodate the at least one wireless earphone; and
a cover, mounted at the casing, and the cover is configured to cover the at least one inner accommodation recess;
wherein the casing or the cover has at least one outer accommodation recess, and the at least one outer accommodation recess is configured to accommodate the at least one microphone.

9. The storage box according to claim 8, wherein the casing has a first surface and a second surface, the second surface faces away from the first surface, the at least one inner accommodation recess is located at the first surface, and the at least one outer accommodation recess is located at the second surface.

10. The storage box according to claim 8, wherein the at least one outer accommodation recess is located at the cover.
